(19) United States
(12) Patent Application Publication
(10) Pub. No.: US 2025/0300732 A1
(43) Pub. Date: Sep. 25, 2025

(54) INTEGRATED POLARIZATION CONTROLLER WITH OPTICAL ATTENUATOR FOR CROSSTALK AND POWER FLUCTUATION REDUCTION

(71) Applicant: Lumentum Operations LLC, San Jose, CA (US)

(72) Inventors: Kangmei LI, San Jose, CA (US); Kenneth A. MCGREER, Livermore, CA (US); Jian WANG, San Jose, CA (US)

(21) Appl. No.: 18/675,901

(22) Filed: May 28, 2024

Related U.S. Application Data
(60) Provisional application No. 63/567,111, filed on Mar. 19, 2024.

(51) Int. Cl. H04B 10/2507; H04J 14/06

(52) U.S. Cl. CPC H04B 10/2572; H04J 14/06

(57) ABSTRACT

A method includes separating, by a polarization splitter rotator, an input light signal into a first light signal having a first insertion loss and a second light signal having a second insertion loss that is different than the first insertion loss; and attenuating, by an optical attenuator, the first light signal or the second light signal in order to compensate for a polarization dependent loss between the first light signal and the second light signal such that a total optical power of the first light signal and the second light signal is independent of a polarization state of the input light signal.

### CROSS-REFERENCE TO RELATED APPLICATION

This Patent application claims priority to U.S. Provisional Patent Application No. 63/567,111, filed on Mar. 19, 2024, and entitled “INTEGRATED ADAPTIVE POLARIZATION CONTROLLER WITH VARIABLE OPTICAL ATTENUATOR FOR CROSSTALK AND POWER FLUCTUATION REDUCTION.” The disclosure of the prior Application is considered part of and is incorporated by reference into this Patent Application.

### TECHNICAL FIELD

The present disclosure relates generally to electro-optical polarization controllers.

### BACKGROUND

Bandwidth demand of data center interconnects is experiencing explosive growth driven by applications, such as artificial intelligence and machine learning. For short-distance links (e.g., links that are less than 1 km) within the data centers, intensity modulation/direct detection (IMDD) is a scheme that is relatively simple and cost-effective. While bandwidth can be increased by using multiple wavelengths in combination with wavelength division multiplexing (WDM) and multiple fibers, as exploited in many modern transceivers, polarization is another degree of freedom that may be utilized to increase bandwidth.

For example, in a dual polarization system, two orthogonal polarizations function as two channels to carry different signals, which has been widely used in coherent communication systems. Moving from a single polarization (SP) IMDD (SP-IMDD) system to a dual polarization (DP) IMDD (DP-IMDD) system requires devices to multiplex and demultiplex two different polarizations, since polarization rotates during transmission in optical fibers.

### SUMMARY

In some implementations, a polarization controller includes a polarization splitter rotator configured to receive an input light signal and separate the input light signal into a first light signal having a first insertion loss and a second light signal having a second insertion loss; and a first mixer stage comprising: a first 2×2 coupler arranged at an output of the first mixer stage; a first optical path coupled to and between the polarization splitter rotator and the first 2×2 coupler, wherein the first optical path is configured to receive the first light signal from the polarization splitter rotator; a second optical path coupled to and between the polarization splitter rotator and the first 2×2 coupler, wherein the second optical path is configured to receive the second light signal from the polarization splitter rotator; a first phase shifter arranged in the first optical path and configured to apply a first phase shift to the first light signal to tune at least a first portion of a relative phase difference between the first light signal and the second light signal to provide a first tuned relative phase difference; and a first optical attenuator arranged in a first one of the first optical path to attenuate the first light signal or in the second optical path to attenuate the second light signal in order to compensate for at least a first portion of a polarization dependent loss between the first light signal and the second light signal.

In some implementations, a polarization controller includes a polarization splitter rotator configured to receive an input light signal and separate the input light signal into a first light signal having a common fundamental transverse mode and a second light signal having the common fundamental transverse mode; and a first mixer stage comprising: a first 2×2 coupler arranged at an output of the first mixer stage; a first optical path coupled to and between the polarization splitter rotator and the first 2×2 coupler, wherein the first optical path is configured to receive the first light signal from the polarization splitter rotator; a second optical path coupled to and between the polarization splitter rotator and the first 2×2 coupler, wherein the first optical path is configured to receive the second light signal from the polarization splitter rotator; a first phase shifter arranged in the first optical path and configured to apply a first phase shift to the first light signal to tune at least a first portion of a relative phase difference between the first light signal and the second light signal to provide a first tuned relative phase; and a first optical attenuator arranged in a first one of the first optical path to add a loss to the first light signal or in the second optical path to add the loss to the second light signal such that a total optical power of the first light signal and the second light signal at the first 2×2 coupler is independent of a polarization state of the input light signal.

In some implementations, a method includes separating, by a polarization splitter rotator, an input light signal into a first light signal having a first insertion loss and a second light signal having a second insertion loss that is different than the first insertion loss; and attenuating, by an optical attenuator, the first light signal or the second light signal in order to compensate for a polarization dependent loss between the first light signal and the second light signal such that a total optical power of the first light signal and the second light signal is independent of a polarization state of the input light signal.

### BRIEF DESCRIPTION OF THE DRAWINGS

FIG. 1A shows a polarization controller according to one or more implementations.

FIG. 1B shows an example of a polarization controller according to one or more implementations.

FIG. 1C shows an example of a polarization controller according to one or more implementations.

FIG. 1D shows an example of an evolution of X and Y signals during transmission through an optical system in which two polarization states are transmitted in a single optical signal.

FIG. 2A shows a polarization controller according to one or more implementations.

FIG. 2B shows a polarization controller according to one or more implementations.

FIG. 3 is a flowchart of an example process associated with an integrated polarization controller with optical attenuator for crosstalk and power fluctuation reduction.

### DETAILED DESCRIPTION

The following detailed description of example implementations refers to the accompanying drawings. The same reference numbers in different drawings may identify the same or similar elements.

A DP-IMDD system requires devices to multiplex and demultiplex two different polarizations, since polarization rotates during transmission in optical fibers. Two orthogonal polarizations may be denoted as X and Y, which are typically a fundamental transverse electric (TE0) mode and a fundamental transverse magnetic (TM0) mode of a transmitter, respectively. For polarization multiplexing, a polarization splitter rotator (PSR) may be used. For polarization demultiplexing, a digital signal processor (DSP) can be used, which may increase system cost and power consumption. As a result, using an electro-optical device for polarization demultiplexing may be more preferable than using a DSP, since the electro-optical device may be less expensive and consume less power. An electro-optical polarization controller (PC) may be used to de-rotate the polarizations and realize polarization demultiplexing.

A bi-directional self-homodyne coherent system is another system that may be used for data center interconnects with a link distance of 10 km or less. Compared with a traditional coherent system, one key feature of the bi-directional self-homodyne coherent system is that the DSP is less complex and consumes less power. In the bi-directional self-homodyne coherent system, a laser source used for generating laser light for a data optical signal is tapped or split, and a split portion of the laser light, having a single polarization, is used as a remote local oscillator (LO) optical signal. The data optical signal may be a mixture of two data signals, an X optical signal and a Y optical signal. The data optical signal and the remote LO optical signal may be transmitted, in parallel, in a fiber pair. As a result, a carrier recovery DSP is not needed, which may reduce DSP complexity and power consumption. Another DSP functionality that consumes a lot of power is polarization demultiplexing. As discussed above, an electro-optical polarization controller may be used to de-rotate polarizations of optical signals, and hence achieve polarization demultiplexing. In addition, a polarization of the remote LO optical signal (single polarized) may also rotate during fiber transmission, and an electro-optical polarization controller can be employed to de-rotate and equally split an optical power of the remote LO optical signal by two to beat (mix) with the X and Y optical signals in respective optical hybrids (e.g., 90° hybrids) at a receiver.

A polarization controller may be potentially used in any other systems that require polarization de-rotation. Another example includes an external laser source (ELS) in a co-packaged optics (CPO) technology, in which external laser modules are packaged separately from silicon photonic chips (e.g., transmitter and/or receiver chips), and short pieces of connection fibers are used to connect lasers of the external laser modules to the silicon photonic chips. While a laser source may output only fundamental transverse electric (TE0) light (e.g., a single polarization), the polarization of laser light may rotate during transmission in the connection fibers before entering the silicon photonic chips. Accordingly, a polarization controller may be used in the transmitter chip to de-rotate the polarization of the laser light. The polarization controller can be a separate device or integrated as part of transmitter chip (or as part of a transceiver chip).

One issue in each of the above-described technologies is that a polarization controller can contribute to polarization dependent loss (PDL), which can cause power fluctuation and crosstalk in the system. Polarization dependent loss is usually inevitable in optical devices and leads to power fluctuation and crosstalk in the case of polarization demultiplexing, power fluctuation in remote LO power splitting, and power fluctuation in ELS applications using polarization controller.

A polarization controller can be made on chip using integrated photonic platforms such as silicon photonics, and hence may be integrated as part of the receiver chip. The polarization controller may include an input port, a PSR, and at least one mixer stage that includes one or more phase shifters and a 2×2 coupler. In a typical application, light from an optical fiber is coupled to the receiver chip at a spot size converter, travels through an optical waveguide, may travel through other optical elements on the receiver chip, and may then enter an input port of the polarization controller. An optical transmission through this input section (e.g., from the optical fiber to the input port of the polarization controller) may experience different loss (PDL) depending on the polarization of the light. For example, fundamental transverse magnetic (TM0) mode light may experience higher loss than fundamental transverse electric (TE0) mode light, which may cause a loss imbalance between the two differently polarized signals (e.g., the X optical signal and the Y optical signal). Another source of PDL might be from the PSR. The light at an input of the PSR may be in TE0 mode. Alternatively, the light at the input of the PSR may be in TM0 mode. In general, the light at the input of the PSR will be a linear combination of two orthogonal modes of light (e.g., TE0 mode and the TM0 mode, or rotated versions thereof). The linear combination may change over time during transmission from the transmitter chip to the receiver chip such that the linear combination changes during an operation of the polarization controller.

The PSR may split the light at the input port into two light signals that have two predefined orthogonal polarizations (e.g., a first light signal with an X polarization and a second light signal with a Y polarization) defined by a physical orientation of the PSR. The two light signals may contain different combinations of the TE0 mode light and the TM0 mode light. The PSR may rotate one of the light signals to have a same polarization as the other light signal. For example, the PSR may rotate the second light signal (having the Y polarization) to have the X polarization. Thus, the two light signals are output from the PSR with the same polarization, but with a phase difference or phase offset. The two light signals may be output from the PSR to a top output arm and a bottom output arm of the polarization controller, respectively. Most of the first light signal may exit the PSR in the X polarization to the top output arm of the polarization controller. A portion of the first light signal that fails to exit the PSR may be referred to as X polarization insertion loss of the PSR. Most of the second light signal may exit the PSR in the Y polarization to the bottom output arm of the polarization controller. A portion of the second light signal that fails to exit the PSR may be referred to as Y polarization insertion loss of the PSR. Typically, the Y polarization insertion loss is greater than the X polarization insertion loss, and the difference in loss is referred to as the PDL of the PSR.

The PDL of the PSR and/or from other sources of PDL located upstream from the PSR may cause power fluctuations and crosstalk in the system. For example, one consequence of the PDL of the PSR is that a total optical power of the two light signals output from the PSR may change when one or more polarizations at the input of the PSR change (e.g., due to rotation during transmission).

Additionally, the total optical power at the input of the PSR may vary based on any PDL introduced upstream from the input of the PSR. Thus, when the total optical power of the two light signals output from the PSR changes as the polarization of the light from an input fiber changes, some performance impairment of the polarization controller is evident in various implementations. Thus, the PDL from one or more PDL sources, including the PSR, may have a negative impact on a performance of the polarization controller.

In addition to unwanted power fluctuations, PDL may cause unwanted cross-talk in the top output arm and/or bottom output arm of the polarization controller. It is desirable to avoid light that is received in polarization state X from exiting on the bottom output arm as much as possible. An amount of light that is received from the first light signal (e.g., corresponding to the polarization state X) that exits a bottom output port of the PSR, relative to the amount of light received from the second light signal (e.g., corresponding to the polarization state Y) that exits the bottom output port, is referred to as X-to-Y crosstalk. Ideally, the X-to-Y crosstalk should be zero. Similarly, it is desirable to avoid light that is received in polarization state Y from exiting on the top output arm as much as possible. An amount of light that is received from the second light signal Y (e.g., corresponding to the polarization state Y) that exits a top output port of the PSR, relative to an amount of light received from the first light signal (e.g., (e.g., corresponding to the polarization state X) that exits the top output port, is referred to as the Y-to-X crosstalk. Ideally, the Y-to-X crosstalk should be zero.

When PDL exists, the X-to-Y crosstalk and/or the Y-to-X crosstalk will be non-zero for any phase setting of the polarization controller. In other words, there will aways be some form of crosstalk that exists at an output stage of the polarization controller when PDL is present. For example, reducing the X-to-Y crosstalk to zero and simultaneously reducing the Y-to-X crosstalk to zero requires that the first light signal and the second light signal be orthogonal in an optical path domain. The first light signal and the second light signal are orthogonal to each other in the optical path domain when an inner product <X|Y> (e.g., according to Dirac's inner product notation) of the first light signal and the second light signal is zero, where X represents the first light signal and Y represents the second light signal. Physically, if <X|Y>=0, X cannot be mapped to Y, or vice versa, and the first light signal and the second light signal are orthogonal to each other in the optical path domain. Orthogonality in the optical path domain has a different meaning from orthogonality in a polarization domain, which refers to two polarizations being orthogonal to each other.

In an absence of PDL, two signal components that are orthogonal to each other in the polarization domain at the input of the PSR will be orthogonal to each other in the optical path domain at the output of the PSR. However, in a case where PDL is present in the input section (e.g., from the optical fiber to the input port of the polarization controller) and PSR, two signal components that are orthogonal to each other in the polarization domain before the input section will not be orthogonal to each other in the optical path domain at the output of the PSR. As a result, crosstalk at the output of the polarization controller will be present for any phase setting of the polarization controller.

Some implementations provide a polarization controller that compensates for PDL that may be introduced by a PSR and/or by one or more components located upstream from the PSR in order to reduce power fluctuations and crosstalk within or at an output of the polarization controller. The polarization controller may be an electro-optical polarization controller fabricated on a photonic chip (e.g., a silicon photonic chip). In some implementations, the polarization controller may be integrated as part of a receiver chip. The polarization controller may include an optical attenuator (e.g., a variable optical attenuator (VOA)) arranged in a top output arm or a bottom output arm that follows the PSR. The optical attenuator may be configured to introduce an additional loss on one of a pair of light signals output from the PSR such that losses experienced by the pair of light signals are balanced, thereby reducing or eliminating the PDL. As a result, power fluctuations and crosstalk can be reduced or eliminated.

In some implementations, the polarization controller may include control electronics that provide dynamic control for the polarization controller in response to one or more input polarization states that change over time. This type of polarization controller may be referred to as an adaptive polarization controller (APC). Optionally, backend phase shifters to tune a relative phase at an output of the polarization controller and/or monitor photodiodes (mPD) that tap a small portion of light at the polarization controller to provide feedback for phase shifter control may be included just prior to the output ports of the polarization controller, to provide adaptive phase tuning based on one or more changing conditions.

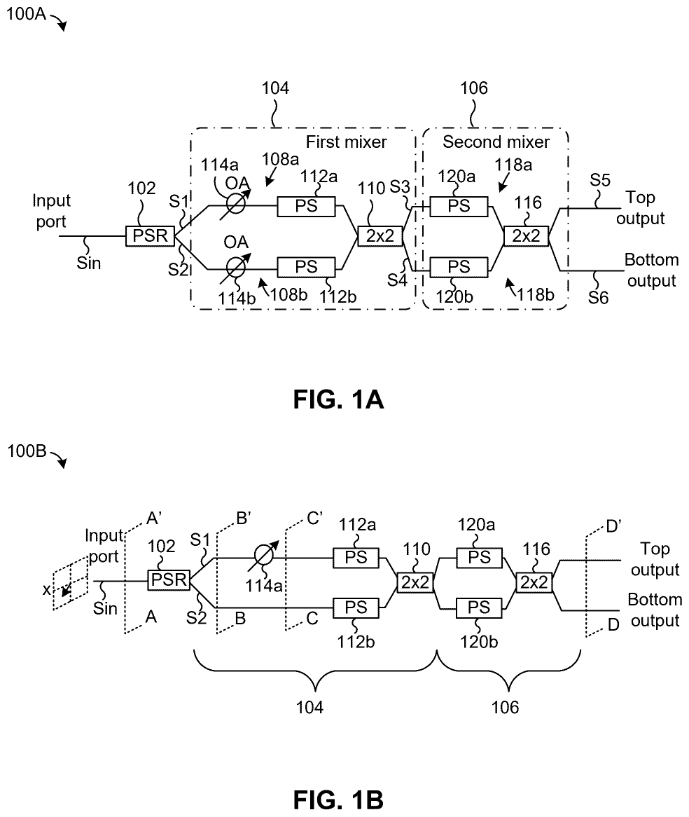

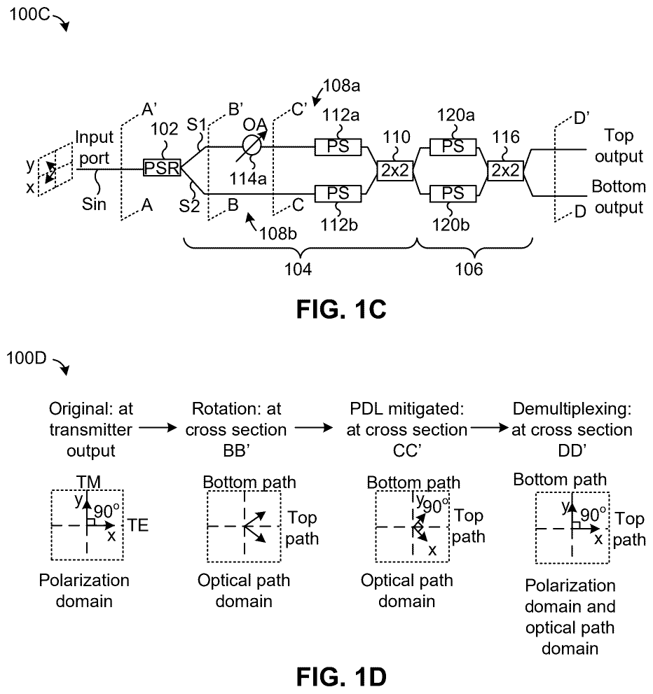

FIG. 1A shows a polarization controller 100A according to one or more implementations. The polarization controller 100A includes an input port, a PSR 102 coupled to the input port, a first mixer stage 104 coupled to output ports of the PSR 102, and a second mixer stage 106 coupled to output ports of the first mixer stage 104. The polarization controller 100A may be a silicon-photonic integrated circuit.

Each mixer stage includes at least one phase shifter (PS) and a 2×2 coupler. In this example, each mixer stage includes a pair of phase shifters. The 2×2 coupler of each mixer stage may be a 3 dB coupler, a 2×2 multi-mode interferometer (MMI), and/or a directional coupler (DC). The 2×2 coupler of each mixer stage may ideally have a 50/50 split ratio. With a 50/50 split ratio, light that enters an input port of a 2×2 coupler is transmitted equally to each of two output ports of the 2×2 coupler. However, a split ratio of the 2×2 coupler may differ slightly from the 50/50 split ratio due to manufacturing tolerances. A phase shifter may be any component that is capable of adjusting a phase delay of light that travels through the phase shifter. For example, a phase shifter may be a doped silicon heater that uses a thermo-optic effect to tune the phase of light passing through the phase shifter.

The polarization controller 100A can be used for polarization de-rotation, polarization demultiplexing, or remote LO power splitting, depending on the settings of the phase shifters, and in some cases, depending on a number of mixer stages. For example, polarization demultiplexing or remote LO power splitting can be achieved by setting a relative phase of the phase shifters correctly. The optical outputs (e.g., top output and bottom output) of the polarization controller 100A may then be guided to either high-speed photodiodes in an DP-IMDD system or to two optical hybrids in a bi-directional self-homodyne coherent system. In the case of an ELS application, incoming light may be de-rotated in polarization by the PSR 102 and then tuned to only one output of the polarization controller with a proper setting of the phase shifters. In other words, the one output of the polarization controller does not provide any output light. The de-rotated light provided by the one output of the polarization controller may then be guided to a transmitter where the de-rotated light may be modulated for data transmission.

The PSR 102 may receive an input light signal Sin and separate the input light signal Sin into a first light signal S1 having a first insertion loss and a second light signal S2 having a second insertion loss that may be different from the first insertion loss. Thus, the first light signal S1 and the second light signal S2 output by the PSR 102 may have a loss imbalance resultant from a PDL of the PSR 102. In other words, a PDL may be based on a difference between the first insertion loss and the second insertion loss. Additionally, the first light signal S1 and the second light signal S2 output by the PSR 102 may have a loss imbalance resultant from one or more PDLs from one or more components located upstream from the PSR 102.

The PSR 102 may output the first light signal to a first optical path 108a (e.g., a top output arm) in a first polarization. Additionally, the PSR 102 may rotate the second light signal from a second polarization to the first polarization, and output the second light signal to a second optical path 108b (e.g., a bottom output arm) in the first polarization. The first polarization may be a common fundamental transverse mode, such as a fundamental transverse electric (TE0) mode. For example, due to polarization rotation of the input light signal Sin during transmission to the PSR 102, the input light signal may have a fundamental transverse electric (TE0) mode component and a fundamental transverse magnetic (TM0) mode component. The PSR 102 may split the fundamental transverse electric (TE0) mode component from the fundamental transverse magnetic (TM0) mode component. The PSR 102 may provide the fundamental transverse electric (TE0) mode component to the first optical path 108a as the first light signal S1 with the first insertion loss. Additionally, the PSR 102 may convert the fundamental transverse magnetic (TM0) mode component into the second light signal S2 (e.g., having the fundamental transverse electric (TE0) mode), and provide the second light signal S2 to the second optical path 108b with the second insertion loss. As a result, the second light signal S2 may experience a greater insertion loss than the first light signal S1, resulting in at least part of the loss imbalance between the first light signal S1 and the second light signal S2 (e.g., at least part of a total PDL).

In some implementations, the input light signal Sin has a single polarization state that changes over time. For example, the single polarization state may rotate as the input light signal Sin propagates through an optical fiber to the PSR 102. In some implementations, the input light signal Sin is a local oscillator signal having a single polarization. In some implementations, the input light signal Sin is provided by a laser source in an ELS application.

In some implementations, the input light signal Sin is a polarization multiplexed carrier signal comprising two data signals having different polarizations and carrying different sets of information. For example, the input light signal Sin may include a first data stream having a first polarization state that changes over time and a second data stream having a second polarization state that changes over time and is different from the first polarization state. For example, the input light signal Sin may be a mixture of two optical signals, such as an X optical signal and a Y optical signal. The two optical signals may be modulated with different data sets. Thus, the X optical signal may be a first data signal and the Y optical signal may be a second data signal. The two optical signals may remain orthogonal to each other during transmission to the input port of the polarization controller 100A, but the orientations of the two polarizations may rotate as the input light signal Sin propagates through an optical fiber to the PSR 102.

The first mixer stage 104 may include a first 2×2 coupler 110 arranged at an output of the first mixer stage 104, the first optical path 108a coupled to and between the PSR 102 and the first 2×2 coupler 110, and the second optical path 108b coupled to and between the PSR 102 and the first 2×2 coupler 110. The first optical path 108a may receive the first light signal S1 from the PSR 102. The second optical path may receive the second light signal S2 from the PSR 102.

The first mixer stage 104 may further include at least one phase shifter (PS). For example, the first mixer stage 104 may include a first phase shifter 112a arranged in the first optical path 108a and configured to apply a first phase shift to the first light signal S1 to tune at least a first portion of a relative phase difference between the first light signal S1 and the second light signal S2 to provide a first tuned relative phase difference. The first mixer stage 104 may include a second phase shifter 112b arranged in the second optical path 108b and configured to apply a second phase shift to the second light signal S2 to tune a second portion of the relative phase difference between the first light signal S1 and the second light signal S2 to provide the first tuned relative phase difference. In some implementations, the first phase shifter 112a or the second phase shifter 112b may be optional. In some implementations, additional phase shifters may be provided in one of or both optical paths 108a and 108b.

The first mixer stage 104 may further include a first optical attenuator 114a arranged in the first optical path 108a to attenuate the first light signal S1 in order to compensate for at least a first portion of a PDL between the first light signal S1 and the second light signal S2. The first optical attenuator 114a may be placed in the optical path 108a or 108b corresponding to the light signal that experiences a smaller insertion loss. For example, if the first insertion loss is less than the second insertion loss, the first optical attenuator 114a may be placed in the first optical path 108a. Conversely, if the second insertion loss is less than the first insertion loss, the first optical attenuator 114a may be placed in the second optical path 108b. If the first polarization is the fundamental transverse electric (TE0) mode and the second polarization is the fundamental transverse magnetic (TM0) mode, the second polarization typically experiences higher loss than the first polarization. Thus, the first optical attenuator 114a may be arranged in the first optical path 108a to attenuate the first light signal S1.

The first optical attenuator 114a may attenuate the first light signal S1 such that the loss imbalance resultant from the polarization dependent loss is reduced (or eliminated). For example, the first optical attenuator 114a may compensate for at least the first portion of the PDL such that the first light signal S1 and the second light signal S2 are orthogonal to each other in an optical path domain. In other words, the first optical attenuator 114a may attenuate the first light signal S1 such that the first light signal S1 and the second light signal S2 received by the first 2×2 coupler 110 are orthogonal to each other in the optical path domain. The first light signal S1 and the second light signal S2 are orthogonal to each other in the optical path domain when an inner product of the first light signal S1 and the second light signal S2 is zero (e.g., <S1|S2>=0). As a result, PDL may be compensated to reduce power fluctuations and/or crosstalk. In some implementations, the PDL may be eliminated such that power fluctuations and/or crosstalk are prevented. Thus, the first optical attenuator 114a may add a loss to the first light signal S1 such that a total optical power of the first light signal S1 and the second light signal S2 at the first 2×2 coupler 110 is independent of a polarization state of the input light signal Sin.

In some implementations, optical attenuators may be placed in both optical paths 108a and 108b, and the optical attenuators may operate in a cooperative manner to compensate for the PDL. For example, the first mixer stage 104 may include a second optical attenuator 114b arranged in the second optical path 108b to attenuate the second light signal S2 in order to compensate for a second portion of the PDL between the first light signal S1 and the second light signal S2. Thus, the first optical attenuator 114a may attenuate the first light signal S1, and the second optical attenuator 114b may attenuate the second light signal S2, such that the first light signal S1 and the second light signal S2 received by the first 2×2 coupler 110 are orthogonal to each other in an optical path domain. The first optical attenuator 114a may attenuate the first light signal S1 and the second optical attenuator 114b may attenuate the second light signal S2 such that a loss of the first light signal S1 (e.g., a total loss of the first light signal S1) is equal to a loss of the second light signal S2 ((e.g., a total loss of the first light signal S1). As a result, the PDL may be compensated to reduce power fluctuations and/or crosstalk. In some implementations, the PDL may be eliminated such that power fluctuations and/or crosstalk are prevented. Thus, the first optical attenuator 114a may add a loss to the first light signal S1 and the second optical attenuator 114b may add a loss to the second light signal S2 such that the total optical power of the first light signal S1 and the second light signal S2 at the first 2×2 coupler 110 is independent of a polarization state of the input light signal Sin.

In some implementations, the first optical attenuator 114a and/or the second optical attenuator 114b may be VOAs that have adjustable attenuations applied to respective light signals. The first optical attenuator 114a and/or the second optical attenuator 114b may be placed anywhere in the first optical path 108a and the second optical path 108b, respectively, as long as the first optical attenuator 114a and the second optical attenuator 114b are between the PSR 102 and the first 2×2 coupler 110.

The first 2×2 coupler 110 may receive the first light signal S1 and the second light signal S2 with the first tuned relative phase difference between the first light signal S1 and the second light signal S2, output a third light signal S3 that includes a first combination of the first light signal S1 and the second light signal S2, and output a fourth light signal S4 that includes a second combination of the first light signal S1 and the second light signal S2. For example, light that enters an input port of the first 2×2 coupler 110 may be transmitted equally to each of two output ports of the first 2×2 coupler 110. Thus, the third light signal S3 may include a first portion (e.g., a first half) of the first light signal S1 and a first portion (e.g., a first half) of the second light signal S2, and the fourth light signal S4 may include a second portion (e.g., a second half) of the first light signal S1 and a second portion (e.g., a second half) of the second light signal S2.

The second mixer stage 106, which in some implementations may be a last mixer stage of the polarization controller 100A, may include a second 2×2 coupler 116 arranged at an output of the second mixer stage 106, a third optical path 118a coupled to and between the first 2×2 coupler 110 and the second 2×2 coupler 116, a fourth optical path 118b coupled to and between the first 2×2 coupler 110 and the second 2×2 coupler 116, a third phase shifter 120a arranged in the third optical path 118a, and a fourth phase shifter 120b arranged in the fourth optical path 118b. The third optical path 118a may receive the third light signal S3 from the first 2×2 coupler 110. The fourth optical path 118b may receive the fourth light signal S4 from the first 2×2 coupler 110. The third phase shifter 120a may apply a third phase shift to the third light signal S3 to tune at least a portion of a second relative phase difference between the third light signal S3 and the fourth light signal S4 to provide a second tuned relative phase difference. The fourth phase shifter 120b may apply a fourth phase shift to the fourth light signal S4 to tune at least a portion of the second relative phase difference between the third light signal S3 and the fourth light signal S4 to provide the second tuned relative phase difference. In some implementations, the third phase shifter 120a or the fourth phase shifter 120b may be optional.

The second 2×2 coupler 116 may receive the third light signal S3 and the fourth light signal S4 with the second tuned relative phase difference between the third light signal S3 and the fourth light signal S4, output a fifth light signal S5 that includes a first combination of the third light signal S3 and the fourth light signal S4, and output a sixth light signal S6 that includes a second combination of the third light signal S3 and the fourth light signal S4. Due to the attenuation applied by the first optical attenuator 114a and/or the second optical attenuator 114b, a power of the fifth light signal S5 may be substantially equal to a power of the sixth light signal S6. In some implementations, the third optical path 118a corresponds to a top output path of the polarization controller 100A, and the fourth optical path 118b corresponds to a bottom output path of the polarization controller 100A.

In some implementations, the input light signal Sin is an LO signal, and the phase shifters 112a, 112b, 120a, and 120b are configured such that the fifth light signal S5 and the sixth light signal S6 are equal halves of the input light signal Sin. In some implementations, the input light signal Sin is a laser light signal with a single polarization, and the phase shifters 112a, 112b, 120a, and 120b are configured such that only the fifth light signal S5 or the sixth light signal S6 is produced with optical power.

In some implementations, the input light signal Sin is a polarization multiplexed carrier signal comprising two data signals having different polarizations and carrying different sets of information, and the phase shifters 112a, 112b, 120a, and 120b are configured such that the fifth light signal S5 includes a first signal component carrying a first set of information, and the sixth light signal S6 includes a second signal component carrying a second set of information. In some implementations, additional mixer stages are used between the first mixer stage 104 and the second mixer stage 106 to separate the first signal component from the second signal component. Alternatively, additional mixer stages may be coupled to the outputs of the second mixer stage 106 and may be used to separate the first signal component from the second signal component. For example, the polarization controller 100A may include at least one further mixer stage coupled to the output of the second mixer stage 106, wherein each further mixer stage includes at least one further phase shifter and a further 2×2 coupler. The at least one further mixer stage may include a final mixer stage comprising a final 2×2 coupler arranged at an output of the polarization controller 100A. The final 2×2 coupler may output a first output light signal carrying the first set of information and a second output light signal carrying the second set of information such that the first output light signal is substantially separated from signal components carrying the second set of information, and the second output light signal is substantially separated from signal components carrying the first set of information. In some implementations, the final 2×2 coupler may output the first output light signal and the second output light signal such that there is no or substantially no crosstalk between the first output light signal and the second output light signal. For example, the first light signal S1 may include a first combination of a first data signal and a second data signal carried in the input light signal Sin, the second light signal S2 may include a second combination of the first data signal and the second data signal, and the first data signal is substantially separated from the second data signal at an output stage (e.g., the final mixer stage) of the polarization controller 100A.

As indicated above, FIG. 1A is provided as an example. Other examples may differ from what is described with regard to FIG. 1A. In practice, the polarization controller 100A may include additional components, fewer components, different components, or differently arranged components than those shown in FIG. 1A without deviating from the disclosure provided above.

FIG. 1B shows an example of a polarization controller 100B related to the polarization controller 100A described in connection with FIG. 1A. In the example shown in FIG. 1B, the input light signal Sin has a single polarization state that is changing over time as the input light signal Sin propagates through a fiber from a transmitter. One consequence of PDL in the PSR 102 and other components before the PSR 102 is that a total optical power of the first light signal S1 and the second light signal S2 at cross-section BB′ changes when an input polarization at cross-section AA′ changes. Thus, the first optical attenuator 114a may add a loss to the first light signal S1 such that the total optical power of the first light signal S1 and the second light signal S2 at the first 2×2 coupler 110 is independent of (or less dependent on) an orientation of the input polarization of the input light signal Sin at cross-section AA′. In other words, the total optical power at cross-section CC′ is independent of (or less dependent on) the input polarization. As a result, the polarization controller 100B may be configured to provide light with equal optical powers at its two outputs such that a total optical power at the output ports is independent of (or less dependent on) the polarization state of the input light signal Sin received at the PSR 102. More generally, since PDL can come from both the input section before the input port of the polarization controller 100B and from the PSR 102, the first optical attenuator 114a may add a loss to the first light signal S1, such that the total optical power at cross-section CC′ (and hence at cross-section DD′) can be maintained constant and independent of (or less dependent on) the polarization of light received from an input fiber.

Alternatively, in the example shown in FIG. 1B, the polarization controller 100B may be configured such that the input light signal Sin (e.g., the single polarized light) is de-rotated from the PSR 102 and tuned to only one output of the polarization controller (cross-section DD′) by the phase shifters 112a, 112b, 120a, and 120b. The output light may then be guided to a transmitter with constant optical power.

In general, a single linear polarization of light is launched from a light source (not illustrated). For example, the single linear polarization may be TE, but could be any polarization. As the light travels through a fiber to the polarization controller 100B, the polarization rotates. Thus, the light arrives as the input light signal Sin at the PSR 102, but is no longer TE light due to the rotation of the polarization during transmission through the fiber. The PSR 102 defines polarization axes. The input light signal Sin has a polarization that, in general, is not aligned to either of those axes. The intent is that the polarization controller 100B may adjust the input light signal Sin to regenerate TE light. The PSR 102 may split the input light signal Sin into two orthogonal polarizations. A portion of the input light signal Sin goes into each of the two polarizations (e.g., X and Y polarizations, where X and Y correspond to the polarization axes of the PSR 102). Next, a rotator of the PSR 102 rotates one of the polarizations (e.g., the Y polarization) such that both light signals output from the PSR have the same X polarization. The phase shifters 112a, 112b, 120a, and 120b may be configured to achieve a desired result at the outputs of the polarization controller 100B. The first optical attenuator 114a helps to reduce power fluctuations and/or crosstalk.

Since a required amount of attenuation may be difficult to predict before a silicon photonics chip is fabricated, the first optical attenuator 114a and/or the second optical attenuator 114b may be VOAs such that the amount of attenuation can be adjusted by control electronics to optimize the amount of attenuation to be applied. The amount of attenuation to be applied may be adjusted such that the total optical power at cross-section CC′ is independent of the input polarization. The amount of attenuation to be applied may be adjusted such that constant optical power is achieved at cross-section DD′. Moreover, the amount of attenuation to be applied may be adjusted such that, in an LO optical path, the remote LO optical signal may be equally divided between the two outputs of the polarization controller 100B with constant power (e.g., in a bi-directional self-homodyne coherent system). The two equal portions of the remote LO optical signal may be provided to respective optical hybrids while maintaining constant LO power at the inputs of the optical hybrids, even as the polarization state of the light received from the fiber changes over time. Moreover, the amount of attenuation to be applied may be adjusted such that, in an ELS application, a laser signal may be directed fully to one output of the polarization controller 100B with constant power, even as the polarization state of the light received from the fiber changes over time. In both cases, PDL may cause unwanted power fluctuations as the polarization state of the light received by the polarization controller 100B from the fiber changes over time.

In general, a VOA can be adjusted to mitigate the combined effect of the PDL from the input section and the PDL from the PSR 102 to make the total optical power at cross-section CC′ substantially independent of the state of polarization of the light from the input optical fiber. In this sense, the first optical attenuator 114a and/or the second optical attenuator 114b may mitigate the impact of any PDL source.

As indicated above, FIG. 1B is provided as an example. Other examples may differ from what is described with regard to FIG. 1B.

FIG. 1C shows an example of a polarization controller 100C related to the polarization controller 100A described in connection with FIG. 1A. In the example shown in FIG. 1C, the input light signal Sin has two polarization states corresponding to respective data signals, and an objective of the polarization controller 100C is to separate the data signals, as output light signals, at the output of the polarization controller 100C with little to no crosstalk. In other words, a first data signal is substantially separated from a second data signal at an output stage of the polarization controller 100C. Two light signals may be generated by a transmitter with orthogonal polarizations TE and TM and transmitted to the polarization controller 100C as the input light signal Sin. As input light signal Sin travels through a fiber, the polarization states rotate, while remaining orthogonal to each other, and the two data signals are attenuated by different amounts due to PDL.

The total optical power at cross-section AA′ varies when the polarization states change upstream from the input port of polarization controller 100C.

In the presence of PDL resulting from components arranged upstream from the input port of the polarization controller 100C and from the PSR 102, a total loss corresponding to the second light signal S2 received by the second optical path 108b is higher than a total loss corresponding to the first light signal S1 received by the first optical path 108a. As a result of the loss imbalance, the first light signal S1 and the second light signal S2 are no longer orthogonal to each other in the optical path domain at cross-section BB′, which would result in crosstalk at cross-section DD′. In the polarization domain, the first light signal S1 and the second light signal S2 have a same polarization state at cross-section BB′ due to the functionality of the PSR 102. The first optical attenuator 114a may be configured to attenuate the first light signal S1 such that the loss imbalance is reduced or eliminated. As a result of the attenuation applied by the first optical attenuator 114a, the PDL may be mitigated, and the first light signal S1 and the second light signal S2 can be made orthogonal to each other, in the optical path domain, at cross-section CC′. By properly tuning the phase settings of the phase shifters 112a, 112b, 120a, and 120b, the first data signal and the second data signal can be substantially separated from each other at cross-section DD′, with the first data signal and the second data signal having orthogonal polarizations in the polarization domain. Moreover, as a result of the attenuation applied by the first optical attenuator 114a, the first data signal and the second data signal at cross-section DD′ may both have constant optical power that is independent of the rotation of the polarization states during transmission through the fiber. As a result, the first data signal and the second data signal originally transmitted by the transmitter may be completely separated from each other such that the top output only contains components of the first data signal and the bottom output only contains components of the second data signal, with no crosstalk.

Since a required amount of attenuation may be difficult to predict before a silicon photonics chip is fabricated, the first optical attenuator 114a and/or the second optical attenuator 114b may be VOAs such that the amount of attenuation can be adjusted by control electronics to optimize the amount of attenuation to be applied. The amount of attenuation to be applied may be adjusted such that the total optical power at cross-section CC′ is independent of the input polarization. The amount of attenuation to be applied may be adjusted such that constant optical power is achieved at cross-section DD′. Moreover, the amount of attenuation to be applied may be adjusted such that, in a DP transmission system, zero or substantially zero crosstalk is achieved at cross-section DD′. In general, a VOA can be adjusted to mitigate the combined effect of the PDL from the input section and the PDL from the PSR 102 to make the total optical power at cross-section CC′ substantially independent of the state of polarization of the light from the input optical fiber. In this sense, the first optical attenuator 114a and/or the second optical attenuator 114b may mitigate the impact of any PDL source.

The example shown in FIG. 1C may be suitable for a receiver in a DP transmission system (e.g., DP-IMDD) or a bi-directional self-homodyne coherent system, which transmits one data stream in a first polarization state and a second data stream in a second polarization state within a single fiber.

As indicated above, FIG. 1C is provided as an example. Other examples may differ from what is described with regard to FIG. 1C.

FIG. 1D shows an example 100D of an evolution of X and Y signals during transmission through an optical system in which two polarization states are transmitted in a single optical signal. The optical system may include the polarization controller 100 described in connection with FIG. 1C. The X and Y signals may be originally transmitted with orthogonal polarizations TE and TM in the polarization domain. However, due to rotation and associated PDL, the X and Y signals are no longer orthogonal to each other in the optical path domain at cross-section BB′. As a result of the attenuation applied by the first optical attenuator 114a, the PDL may be mitigated, and the first light signal S1 and the second light signal S2 can be made orthogonal to each other, in the optical path domain, at cross-section CC′. As a result of the attenuation applied by the first optical attenuator 114a, the X and Y signals can be recovered as separate signals at cross-section DD′, with the X and Y signals being orthogonal to each other in both the polarization domain and the optical path domain.

As indicated above, FIG. 1D is provided as an example. Other examples may differ from what is described with regard to FIG. 1D.

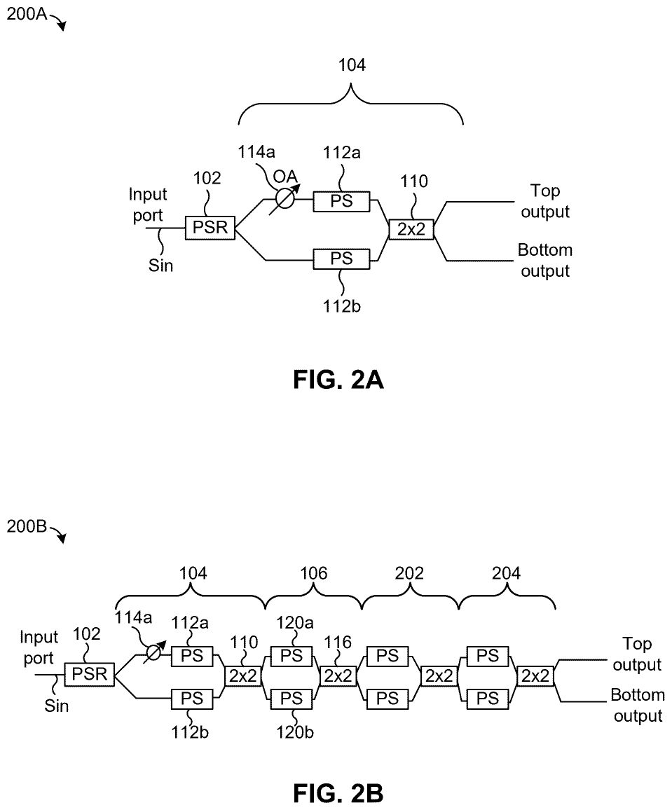

FIG. 2A shows a polarization controller 200A according to one or more implementations. The polarization controller 200A may be similar to the polarization controller 100 described in connection with FIG. 1A, with the exception that the polarization controller 200A is a single mixer stage polarization controller. Thus, the polarization controller 200A includes only the first mixer stage 104, and two output signals are provided from the first 2×2 coupler 110 of the first mixer stage 104. In some implementations, a single mixer stage may be sufficient to equally split an LO optical signal or to generate laser light for an ELS application.

As indicated above, FIG. 2A is provided as an example. Other examples may differ from what is described with regard to FIG. 2A.

FIG. 2B shows a polarization controller 200B according to one or more implementations. The polarization controller 200B may be similar to the polarization controller 100 described in connection with FIG. 1A, with the exception that the polarization controller 200B includes four mixer stages, including the first mixer stage 104, the second mixer stage 106 and two further mixer stages 202 and 204. The last mixer stage (e.g., mixer stage 204) may be referred to as the final mixer stage. The further mixer stages 202 and 204 may be needed in some applications to sufficiently separate two data signals at the outputs of the polarization controller 200B in a dual polarization system (e.g., to recover X and Y signals with orthogonal polarizations). In some implementations, additional phase shifters and/or mPDs may be provided at the outputs of the polarization controller 200B to provide additional phase tuning and/or phase shift feedback control. When the polarization controller is configured with control electronics that provide dynamic control for the polarization controller 200B in response to input polarization states that change over time, the polarization controller 200B may be referred to as an APC.

As indicated above, FIG. 2B is provided as an example. Other examples may differ from what is described with regard to FIG. 2B.

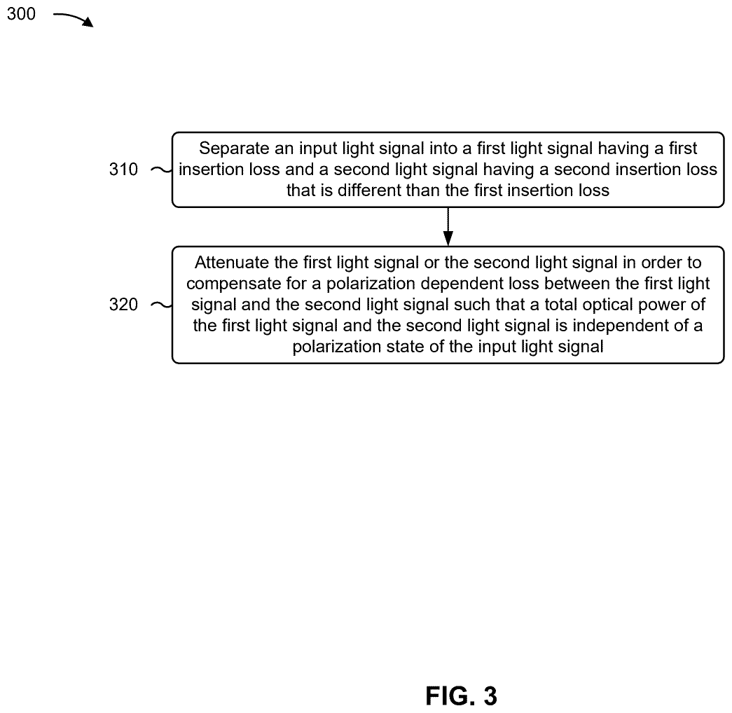

FIG. 3 is a flowchart of an example process 300 associated with an integrated polarization controller with optical attenuator for crosstalk and power fluctuation reduction. In some implementations, one or more process blocks of FIG. 3 are performed by a polarization controller (e.g., polarization controller 100, 200A, or 200B). Additionally, or alternatively, one or more process blocks of FIG. 3 may be performed by one or more components of a polarization controller, such as the PSR 102, the first optical attenuator 114a, the second optical attenuator 114b, and/or one or more mixer stages.

As shown in FIG. 3, process 300 may include separating an input light signal into a first light signal having a first insertion loss and a second light signal having a second insertion loss that is different than the first insertion loss (block 310). For example, the PSR 102 may separate an input light signal into a first light signal having a first insertion loss and a second light signal having a second insertion loss that is different than the first insertion loss, as described above.

As further shown in FIG. 3, process 300 may include attenuating the first light signal or the second light signal in order to compensate for a polarization dependent loss between the first light signal and the second light signal such that a total optical power of the first light signal and the second light signal is independent of a polarization state of the input light signal (block 320). For example, the first optical attenuator 114a may attenuate the first light signal or the second light signal in order to compensate for a polarization dependent loss between the first light signal and the second light signal such that a total optical power of the first light signal and the second light signal is independent of a polarization state of the input light signal, as described above.

Process 300 may include additional implementations, such as any single implementation or any combination of implementations described below and/or in connection with one or more other processes described elsewhere herein.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

The following provides an overview of some Aspects of the present disclosure:
Aspect 1: A polarization controller, comprising: a polarization splitter rotator configured to receive an input light signal and separate the input light signal into a first light signal having a first insertion loss and a second light signal having a second insertion loss; and a first mixer stage comprising: a first 2×2 coupler arranged at an output of the first mixer stage; a first optical path coupled to and between the polarization splitter rotator and the first 2×2 coupler, wherein the first optical path is configured to receive the first light signal from the polarization splitter rotator; a second optical path coupled to and between the polarization splitter rotator and the first 2×2 coupler, wherein the second optical path is configured to receive the second light signal from the polarization splitter rotator; a first phase shifter arranged in the first optical path and configured to apply a first phase shift to the first light signal to tune at least a first portion of a relative phase difference between the first light signal and the second light signal to provide a first tuned relative phase difference; and a first optical attenuator arranged in a first one of the first optical path to attenuate the first light signal or in the second optical path to attenuate the second light signal in order to compensate for at least a first portion of a polarization dependent loss between the first light signal and the second light signal.
Aspect 2: The polarization controller of Aspect 1, wherein the first 2×2 coupler is configured to receive the first light signal and the second light signal with the first tuned relative phase difference between the first light signal and the second light signal, output a third light signal comprising a first combination of the first light signal and the second light signal, and output a fourth light signal comprising a second combination of the first light signal and the second light signal.
Aspect 3: The polarization controller of Aspect 2, wherein the first 2×2 coupler is a 3 dB coupler.
Aspect 4: The polarization controller of any of Aspects 1-3, wherein the first light signal and the second light signal, output by the polarization splitter rotator, have a loss imbalance resultant from the polarization dependent loss, and wherein the first optical attenuator is configured to attenuate the first light signal or the second light signal such that the loss imbalance resultant from the polarization dependent loss is reduced.
Aspect 5: The polarization controller of any of Aspects 1-4, wherein the polarization splitter rotator is configured to receive the input light signal, wherein the polarization splitter rotator is configured to output the first light signal to the first optical path in a first polarization, rotate the second light signal from a second polarization to the first polarization, and output the second light signal to the second optical path in the first polarization, and wherein the first optical attenuator is configured to compensate for at least the first portion of the polarization dependent loss such that the first light signal and the second light signal are orthogonal to each other in an optical path domain.
Aspect 6: The polarization controller of Aspect 5, wherein the first optical attenuator is configured to attenuate the first light signal or the second light signal such that the first light signal and the second light signal received by the first 2×2 coupler are orthogonal to each other in the optical path domain.
Aspect 7: The polarization controller of Aspect 5, wherein the first light signal and the second light signal are orthogonal to each other in the optical path domain when an inner product of the first light signal and the second light signal is zero.
Aspect 8: The polarization controller of Aspect 5, wherein the first polarization is a transverse electric (TE) fundamental mode and the second polarization is a transverse magnetic (TM) fundamental mode, and wherein the first optical attenuator is arranged in the first optical path for attenuating the first light signal.
Aspect 9: The polarization controller of any of Aspects 1-8, further comprising: a second phase shifter arranged in the second optical path, wherein the second phase shifter is configured to apply a second phase shift to the second light signal to tune a second portion of the relative phase difference between the first light signal and the second light signal to provide the first tuned relative phase difference.
Aspect 10: The polarization controller of any of Aspects 1-9, further comprising: a second optical attenuator arranged in a second one of the first optical path to attenuate the first light signal or the second optical path to attenuate the second light signal in order to compensate for a second portion of the polarization dependent loss between the first light signal and the second light signal.
Aspect 11: The polarization controller of Aspect 10, wherein the first optical attenuator is configured to attenuate the first light signal and the second optical attenuator is configured to attenuate the second light signal such that the first light signal and the second light signal received by the first 2×2 coupler are orthogonal to each other in an optical path domain.
Aspect 12: The polarization controller of Aspect 10, wherein the first optical attenuator is configured to attenuate the first light signal and the second optical attenuator is configured to attenuate the second light signal such that a loss of the first light signal is equal to a loss of the second light signal.
Aspect 13: The polarization controller of any of Aspects 1-12, further comprising:a second mixer stage comprising:a second 2×2 coupler arranged at an output of the second mixer stage; a third optical path coupled to and between the first 2×2 coupler and the second 2×2 coupler, wherein the third optical path is configured to receive a third light signal from the first 2×2 coupler; a fourth optical path coupled to and between the first 2×2 coupler and the second 2×2 coupler, wherein the fourth optical path is configured to receive a fourth light signal from the first 2×2 coupler; and a second phase shifter arranged in the third optical path and configured to apply a second phase shift to the third light signal to tune at least a portion of a second relative phase difference between the third light signal and the fourth light signal to provide a second tuned relative phase difference.
Aspect 14: The polarization controller of Aspect 13, wherein the second 2×2 coupler is configured to receive the third light signal and the fourth light signal with the second tuned relative phase difference between the third light signal and the fourth light signal, output a fifth light signal comprising a first combination of the third light signal and the fourth light signal, and output a sixth light signal comprising a second combination of the third light signal and the fourth light signal, wherein a power of the fifth light signal is substantially equal to a power of the sixth light signal.
Aspect 15: The polarization controller of Aspect 14, wherein the input light signal is a local oscillator signal having a single polarization.
Aspect 16: The polarization controller of Aspect 13, wherein the second 2×2 coupler is configured to receive the third light signal and the fourth light signal with the second tuned relative phase difference between the third light signal and the fourth light signal, output a fifth light signal comprising a first combination of the third light signal and the fourth light signal, and output a sixth light signal comprising a second combination of the third light signal and the fourth light signal, wherein the fifth light signal includes a first signal component carrying a first set of information, and wherein the sixth light signal includes a second signal component carrying a second set of information.
Aspect 17: The polarization controller of Aspect 16, wherein the input light signal is a polarization multiplexed carrier signal comprising two data signals having different polarizations and carrying different sets of information.
Aspect 18: The polarization controller of Aspect 13, further comprising: at least one further mixer stage coupled to the output of the second mixer stage, wherein each further mixer stage includes at least one further phase shifter and a further 2×2 coupler, wherein the at least one further mixer stage includes a final mixer stage comprising a final 2×2 coupler arranged at an output of the polarization controller, wherein the final 2×2 coupler is configured to output a first output light signal carrying a first set of information and a second output light signal carrying a second set of information, wherein the first output light signal is substantially separated from signal components carrying the second set of information, and wherein the second output light signal is substantially separated from signal components carrying the first set of information.
Aspect 19: The polarization controller of any of Aspects 1-18, wherein the polarization dependent loss is based on a difference between the first insertion loss and the second insertion loss.
Aspect 20: The polarization controller of any of Aspects 1-19, wherein the input light signal has a single polarization state that changes over time.
Aspect 21: The polarization controller of any of Aspects 1-20, wherein the input light signal includes a first data stream having a first polarization state that changes over time and a second data stream having a second polarization state that changes over time and is different from the first polarization state.
Aspect 22: The polarization controller of any of Aspects 1-21, wherein the first optical attenuator is a variable optical attenuator.
Aspect 23: The polarization controller of any of Aspects 1-22, wherein the polarization controller is integrated in a silicon-photonic integrated circuit.
Aspect 24: The polarization controller of any of Aspects 1-23, wherein the first light signal includes a first combination of a first data signal and a second data signal, wherein the second light signal includes a second combination of the first data signal and the second data signal, and wherein the first data signal is substantially separated from the second data signal at an output stage of the polarization controller.
Aspect 25: A polarization controller, comprising: a polarization splitter rotator configured to receive an input light signal and separate the input light signal into a first light signal having a common fundamental transverse mode and a second light signal having the common fundamental transverse mode; and a first mixer stage comprising: a first 2×2 coupler arranged at an output of the first mixer stage; a first optical path coupled to and between the polarization splitter rotator and the first 2×2 coupler, wherein the first optical path is configured to receive the first light signal from the polarization splitter rotator; a second optical path coupled to and between the polarization splitter rotator and the first 2×2 coupler, wherein the first optical path is configured to receive the second light signal from the polarization splitter rotator; a first phase shifter arranged in the first optical path and configured to apply a first phase shift to the first light signal to tune at least a first portion of a relative phase difference between the first light signal and the second light signal to provide a first tuned relative phase; and a first optical attenuator arranged in a first one of the first optical path to add a loss to the first light signal or in the second optical path to add the loss to the second light signal such that a total optical power of the first light signal and the second light signal at the first 2×2 coupler is independent of a polarization state of the input light signal.
Aspect 26: The polarization controller of Aspect 25, wherein the input light signal has a fundamental transverse electric mode component and a fundamental transverse magnetic mode component, wherein the common fundamental transverse mode is a fundamental transverse electric mode, and wherein the polarization splitter rotator is configured to provide the fundamental transverse electric mode component to the first optical path as the first light signal with a first insertion loss, convert the fundamental transverse magnetic mode component into the second light signal, and provide the second light signal to the second optical path with a second insertion loss.
Aspect 27: A method, comprising: separating, by a polarization splitter rotator, an input light signal into a first light signal having a first insertion loss and a second light signal having a second insertion loss that is different than the first insertion loss; and attenuating, by an optical attenuator, the first light signal or the second light signal in order to compensate for a polarization dependent loss between the first light signal and the second light signal such that a total optical power of the first light signal and the second light signal is independent of a polarization state of the input light signal.
Aspect 28: A system configured to perform one or more operations recited in one or more of Aspects 1-27.
Aspect 29: An apparatus comprising means for performing one or more operations recited in one or more of Aspects 1-27.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A polarization controller, comprising:
a polarization splitter rotator configured to receive an input light signal and separate the input light signal into a first light signal having a first insertion loss and a second light signal having a second insertion loss; and
a first mixer stage comprising:
a first 2×2 coupler arranged at an output of the first mixer stage;
a first optical path coupled to and between the polarization splitter rotator and the first 2×2 coupler, wherein the first optical path is configured to receive the first light signal from the polarization splitter rotator;
a second optical path coupled to and between the polarization splitter rotator and the first 2×2 coupler, wherein the second optical path is configured to receive the second light signal from the polarization splitter rotator;
a first phase shifter arranged in the first optical path and configured to apply a first phase shift to the first light signal to tune at least a first portion of a relative phase difference between the first light signal and the second light signal to provide a first tuned relative phase difference; and
a first optical attenuator arranged in a first one of the first optical path to attenuate the first light signal or in the second optical path to attenuate the second light signal in order to compensate for at least a first portion of a polarization dependent loss between the first light signal and the second light signal.

2. The polarization controller of claim 1, wherein the first 2×2 coupler is configured to receive the first light signal and the second light signal with the first tuned relative phase difference between the first light signal and the second light signal, output a third light signal comprising a first combination of the first light signal and the second light signal, and output a fourth light signal comprising a second combination of the first light signal and the second light signal.

3. The polarization controller of claim 2, wherein the first 2×2 coupler is a 3 dB coupler.

4. The polarization controller of claim 1, wherein the first light signal and the second light signal, output by the polarization splitter rotator, have a loss imbalance resultant from the polarization dependent loss, and
wherein the first optical attenuator is configured to attenuate the first light signal or the second light signal such that the loss imbalance resultant from the polarization dependent loss is reduced.

5. The polarization controller of claim 1,
wherein the polarization splitter rotator is configured to receive the input light signal,
wherein the polarization splitter rotator is configured to output the first light signal to the first optical path in a first polarization, rotate the second light signal from a second polarization to the first polarization, and output the second light signal to the second optical path in the first polarization, and
wherein the first optical attenuator is configured to compensate for at least the first portion of the polarization dependent loss such that the first light signal and the second light signal are orthogonal to each other in an optical path domain.

6. The polarization controller of claim 5, wherein the first optical attenuator is configured to attenuate the first light signal or the second light signal such that the first light signal and the second light signal received by the first 2×2 coupler are orthogonal to each other in the optical path domain.

7. The polarization controller of claim 5, wherein the first light signal and the second light signal are orthogonal to each other in the optical path domain when an inner product of the first light signal and the second light signal is zero.

8. The polarization controller of claim 5, wherein the first polarization is a transverse electric (TE) fundamental mode and the second polarization is a transverse magnetic (TM) fundamental mode, and
wherein the first optical attenuator is arranged in the first optical path for attenuating the first light signal.

9. The polarization controller of claim 1, further comprising:
a second phase shifter arranged in the second optical path, wherein the second phase shifter is configured to apply a second phase shift to the second light signal to tune a second portion of the relative phase difference between the first light signal and the second light signal to provide the first tuned relative phase difference.

10. The polarization controller of claim 1, further comprising:
a second optical attenuator arranged in a second one of the first optical path to attenuate the first light signal or the second optical path to attenuate the second light signal in order to compensate for a second portion of the polarization dependent loss between the first light signal and the second light signal.

11. The polarization controller of claim 10, wherein the first optical attenuator is configured to attenuate the first light signal and the second optical attenuator is configured to attenuate the second light signal such that the first light signal and the second light signal received by the first 2×2 coupler are orthogonal to each other in an optical path domain.

12. The polarization controller of claim 10, wherein the first optical attenuator is configured to attenuate the first light signal and the second optical attenuator is configured to attenuate the second light signal such that a loss of the first light signal is equal to a loss of the second light signal.

13. The polarization controller of claim 1, further comprising:
a second mixer stage comprising:
a second 2×2 coupler arranged at an output of the second mixer stage;
a third optical path coupled to and between the first 2×2 coupler and the second 2×2 coupler, wherein the third optical path is configured to receive a third light signal from the first 2×2 coupler;
a fourth optical path coupled to and between the first 2×2 coupler and the second 2×2 coupler, wherein the fourth optical path is configured to receive a fourth light signal from the first 2×2 coupler; and
a second phase shifter arranged in the third optical path and configured to apply a second phase shift to the third light signal to tune at least a portion of a second relative phase difference between the third light signal and the fourth light signal to provide a second tuned relative phase difference.

14. The polarization controller of claim 13, wherein the second 2×2 coupler is configured to receive the third light signal and the fourth light signal with the second tuned relative phase difference between the third light signal and the fourth light signal, output a fifth light signal comprising a first combination of the third light signal and the fourth light signal, and output a sixth light signal comprising a second combination of the third light signal and the fourth light signal,
wherein a power of the fifth light signal is substantially equal to a power of the sixth light signal.

15. The polarization controller of claim 14, wherein the input light signal is a local oscillator signal having a single polarization.

16. The polarization controller of claim 13, wherein the second 2×2 coupler is configured to receive the third light signal and the fourth light signal with the second tuned relative phase difference between the third light signal and the fourth light signal, output a fifth light signal comprising a first combination of the third light signal and the fourth light signal, and output a sixth light signal comprising a second combination of the third light signal and the fourth light signal,
wherein the fifth light signal includes a first signal component carrying a first set of information, and
wherein the sixth light signal includes a second signal component carrying a second set of information.

17. The polarization controller of claim 16, wherein the input light signal is a polarization multiplexed carrier signal comprising two data signals having different polarizations and carrying different sets of information.

18. The polarization controller of claim 13, further comprising:
at least one further mixer stage coupled to the output of the second mixer stage, wherein each further mixer stage includes at least one further phase shifter and a further 2×2 coupler,
wherein the at least one further mixer stage includes a final mixer stage comprising a final 2×2 coupler arranged at an output of the polarization controller,
wherein the final 2×2 coupler is configured to output a first output light signal carrying a first set of information and a second output light signal carrying a second set of information,
wherein the first output light signal is substantially separated from signal components carrying the second set of information, and
wherein the second output light signal is substantially separated from signal components carrying the first set of information.

19. The polarization controller of claim 1, wherein the polarization dependent loss is based on a difference between the first insertion loss and the second insertion loss.

20. The polarization controller of claim 1, wherein the input light signal has a single polarization state that changes over time.

21. The polarization controller of claim 1, wherein the input light signal includes a first data stream having a first polarization state that changes over time and a second data stream having a second polarization state that changes over time and is different from the first polarization state.

22. The polarization controller of claim 1, wherein the first optical attenuator is a variable optical attenuator.

23. The polarization controller of claim 1, wherein the polarization controller is integrated in a silicon-photonic integrated circuit.

24. The polarization controller of claim 1, wherein the first light signal includes a first combination of a first data signal and a second data signal,
wherein the second light signal includes a second combination of the first data signal and the second data signal, and
wherein the first data signal is substantially separated from the second data signal at an output stage of the polarization controller.

25. A polarization controller, comprising:
a polarization splitter rotator configured to receive an input light signal and separate the input light signal into a first light signal having a common fundamental transverse mode and a second light signal having the common fundamental transverse mode; and
a first mixer stage comprising:
a first 2×2 coupler arranged at an output of the first mixer stage;
a first optical path coupled to and between the polarization splitter rotator and the first 2×2 coupler, wherein the first optical path is configured to receive the first light signal from the polarization splitter rotator;
a second optical path coupled to and between the polarization splitter rotator and the first 2×2 coupler, wherein the first optical path is configured to receive the second light signal from the polarization splitter rotator;
a first phase shifter arranged in the first optical path and configured to apply a first phase shift to the first light signal to tune at least a first portion of a relative phase difference between the first light signal and the second light signal to provide a first tuned relative phase; and
a first optical attenuator arranged in a first one of the first optical path to add a loss to the first light signal or in the second optical path to add the loss to the second light signal such that a total optical power of the first light signal and the second light signal at the first 2×2 coupler is independent of a polarization state of the input light signal.

26. The polarization controller of claim 25, wherein the input light signal has a fundamental transverse electric mode component and a fundamental transverse magnetic mode component,
wherein the common fundamental transverse mode is a fundamental transverse electric mode, and
wherein the polarization splitter rotator is configured to provide the fundamental transverse electric mode component to the first optical path as the first light signal with a first insertion loss, convert the fundamental transverse magnetic mode component into the second light signal, and provide the second light signal to the second optical path with a second insertion loss.

27. A method, comprising:
separating, by a polarization splitter rotator, an input light signal into a first light signal having a first insertion loss and a second light signal having a second insertion loss that is different than the first insertion loss; and
attenuating, by an optical attenuator, the first light signal or the second light signal in order to compensate for a polarization dependent loss between the first light signal and the second light signal such that a total optical power of the first light signal and the second light signal is independent of a polarization state of the input light signal.
